(19) United States
(12) Patent Application Publication
(10) Pub. No.: US 2019/0015970 A1
(43) Pub. Date: Jan. 17, 2019

(54) REACHING AND GRABBING DEVICE

(71) Applicant: Max SANTOMAURO, Pueblo, CO (US)

(72) Inventor: Max SANTOMAURO, Pueblo, CO (US)

(21) Appl. No.: 16/033,001

(22) Filed: Jul. 11, 2018

Related U.S. Application Data
(60) Provisional application No. 62/531,675, filed on Jul. 12, 2017.

(51) Int. Cl. B25J 1/04; A47F 13/06

(52) U.S. Cl. CPC B25J 1/04; A45B 2009/007; A47F 13/06

(57) ABSTRACT

Devices for reaching and grabbing objects suffer from one or more drawbacks. They are unable to grab irregular or heavy object. The present disclosure relates to a device for reaching and grabbing object, including a support comprising a first grip and a rest. An elongated shaft is coupled to the support. A securing mechanism is also coupled to the support. The securing mechanism includes a support plate and a backer plate to which an object can be secured. A loop mechanism may be coupled to the distal end of the elongated shaft and used to secure the object to the grabbing device. The diameter of the loop mechanism can be adjusted by a user at the proximal end of the grabbing device to secure the object to the device.

### CROSS-REFERENCE TO RELATED APPLICATIONS

This application claims the benefit of U.S. Provisional Patent Application Ser. No. 62/531,675, filed on Jul. 12, 2017, which is incorporated by reference herein in its entirety for all purposes.

### TECHNICAL FIELD

Embodiments of the present disclosure relate generally to a device for reaching and grabbing an object.

### BACKGROUND

Often, certain types of devices for reaching and grabbing objects suffer from one or more drawbacks. Most of these devices utilize a claw to grip an object. Claws have several known limitations. For example, spherical, cylindrical and otherwise rounded objects can be difficult to grab without the risk of slipping. Additionally, the construction of most grabbing devices including an actuation handle and a claw or other type of gripper can significantly limit the tool's use to grab objects that are heavy. Claw grippers often cannot be reliably used to reach and grab objects that weigh more than a few pounds.

### SUMMARY

A device for grabbing an object according to embodiments of the present disclosure includes a support comprising a first grip and a rest; an elongated shaft having a proximal end and a distal end, wherein the proximal end of the elongated shaft is coupled to the support; a securing mechanism comprising a backer plate and a support plate, wherein a first end of the backer plate is coupled to the distal end of the elongated shaft and a second end of the backer plate is coupled to the support plate; a second grip coupled to the elongated shaft; and a loop mechanism having a first end and a second end, wherein the first end of the loop mechanism is coupled to the distal end of the elongated shaft, wherein the loop mechanism is configured to selectively secure the object to the securing member.

The device of paragraph [0004], further comprising an actuating rod having first and second ends, wherein the first end of the actuating rod is coupled to the support plate and the second end of the actuating rod is coupled to the second grip, and wherein the actuating rod is configured to rotate the support plate along the shaft.

The device of any of paragraphs [0004] to [0005], further comprising a first toothed channel coupled to the elongated shaft, wherein the second grip is slidably coupled to the first toothed channel.

The device of any of paragraphs [0004] to [0006], the first toothed channel comprises teeth and wherein the second grip is configured to selectively engage the teeth of the first toothed channel to lock an orientation of the securing mechanism.

The device of any of paragraphs [0004] to [0007], wherein the backer plate is pivotally coupled to the distal end of the elongated shaft.

The device of any of paragraphs [0004] to [0008], wherein the backer plate has an adjustable length.

The device of any of paragraphs [0004] to [0009], wherein the loop mechanism is configured to extend around the object.

The device of any of paragraphs [0004] to [0010], further comprising a second toothed channel coupled to the proximal end of the elongated shaft, wherein the support is slidably coupled to the second toothed channel.

The device of any of paragraphs [0004] to [0011], further comprising a securing rod having a distal end and a proximal end, wherein the distal end of the securing rod is operatively coupled to the loop mechanism.

The device of any of paragraphs [0004] to [0012], wherein the proximal end of the securing rod is coupled to the support.

The device of any of paragraphs [0004] to [0013], wherein the support is configured to slide relative to the second toothed channel, and wherein sliding the support moves the securing rod to open or close the loop mechanism around the object.

The device of any of paragraphs [0004] to [0014], wherein the support is configured to selectively engage the teeth of the second toothed channel to lock the loop mechanism.

The device of any of paragraphs [0004] to [0015], further comprising a securing cable having a distal end and a proximal end, wherein the distal end of the securing cable is operatively coupled to the loop mechanism.

The device of any of paragraphs [0004] to [0016], further comprising a reel operatively coupled to the proximal end of the securing cable.

The device of any of paragraphs [0004] to [0017], wherein the support member is configured to fold against the backer plate.

A method for grabbing an object according to embodiments of the present disclosure includes positioning a support member under the object; positioning a backer plate having a first end and a second end next to the object, wherein the first end of the backer plate is coupled to an elongated shaft having a proximal end and a distal end and the second end of the backer plate is coupled to the support member; positioning a loop mechanism around the object, wherein the loop mechanism is operatively coupled to a securing rod, wherein the securing rod extends from the distal end of the elongated shaft to the proximal end of the elongated shaft, and wherein the securing rod is operatively coupled to a support; and sliding the support to secure the object to the backer plate.

The method of paragraph [0019], further comprising securing the support to lock the object to the backer plate.

The method of any of paragraphs [0019] to [0020], further comprising sliding a grip operatively coupled to the support member and the backer plate to change the orientation of the support member and the backer plate.

The method of any of paragraphs [0019] to [0021], further comprising securing the grip to lock the orientation of the support member and the backer plate.

The method of any of paragraphs [0019] to [0022], further comprising moving the object from a first location to a second location.

While multiple embodiments are disclosed, still other embodiments of the present disclosure will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a grabbing device in accordance with embodiments of the present disclosure.

FIG. 2 illustrates a securing mechanism of a grabbing device according to embodiments of the present disclosure.

FIG. 3 illustrates a support of a grabbing device according to embodiments of the present disclosure.

FIG. 4 illustrates a gripping mechanism of a grabbing device according to embodiments of the present disclosure.

FIGS. 5-8 show methods of using the grabbing device according to embodiments of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

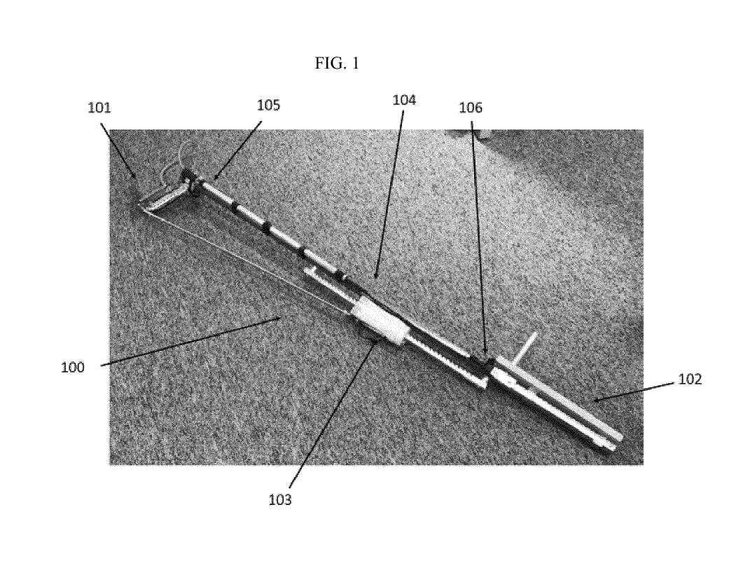

FIG. 1 depicts a grabbing device 100 according to embodiments of the present disclosure. Grabbing device 100 includes securing mechanism 101, support 102, and grip 103. An elongated shaft 104 has a distal end 105 and a proximal end 106. The elongated shaft 104 can be of constructed of any material that is both strong enough to support the weight of the object grabbed by the device, as well as light enough to permit the grabbing device to be easily lifted and maneuvered. For example, the elongated shaft 104 can be made of aluminum, carbon fiber, plastic, or any other strong yet lightweight material. In some embodiments, elongated shaft 104 can be hollow to permit a cable or rod to extend from the distal end 105 to the proximal end 106 as described in further detail below. Elongated shaft 104 can also alternatively include a channel embedded in an outer wall to allow the cable or rod to extend from the distal end 105 to the proximal end 106 as described in further detail below.

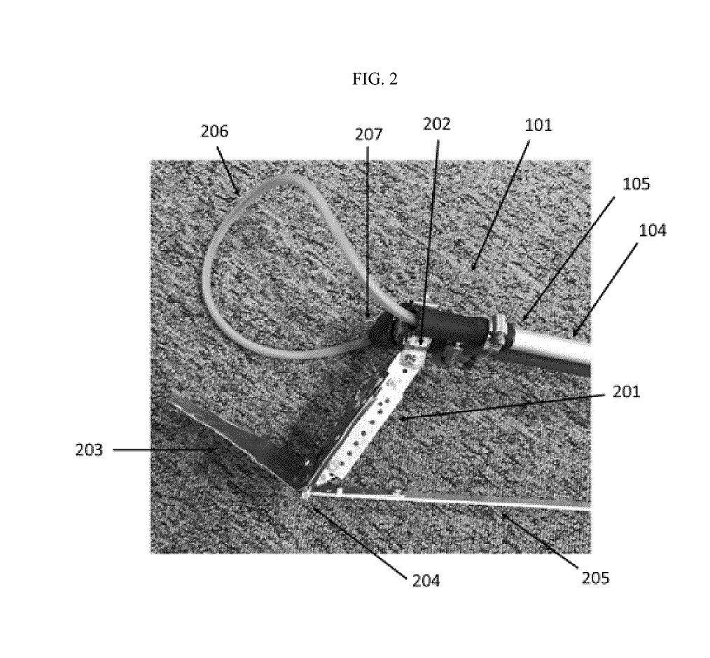

The distal end 105 of the elongated shaft 104 is operatively coupled to the securing mechanism 101. FIG. 2 illustrates elements of the securing mechanism 101. In one embodiment, the distal end 105 of the elongated shaft 104 includes a bracket that is connected to the securing mechanism 101. In other embodiments, the securing mechanism 101 is coupled to the elongated shaft 104 using a bolt and nut extending through the rod. Such a configuration allows securing mechanism 101 to rotate or pivot about the distal end 105 of the elongated shaft 104, according to some embodiments.

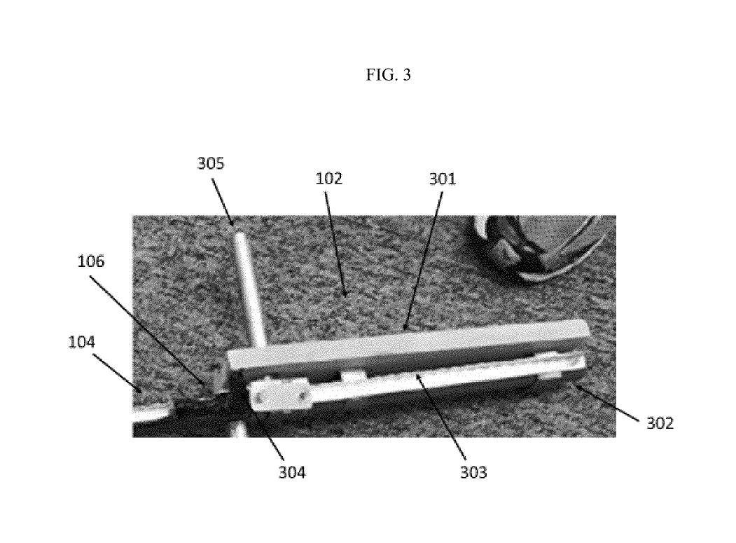

The proximal end 106 of the elongated shaft 104 is operatively coupled to a support 102. FIG. 3 illustrates elements of the support 102. There are many ways to couple the distal end 106 of elongated shaft 104 to the support 102. For example, if both components are metal, elongated shaft 104 and support 102 can be welded together. Alternatively, the elongated shaft 104 can include a bracket that can be used to secure the support 102 to the distal end 106 of the elongated shaft 104. Other ways of securing the support 102 to the elongated shaft 104 include bolting, gluing, taping, and/or using any other suitable adhesive, according to some embodiments.

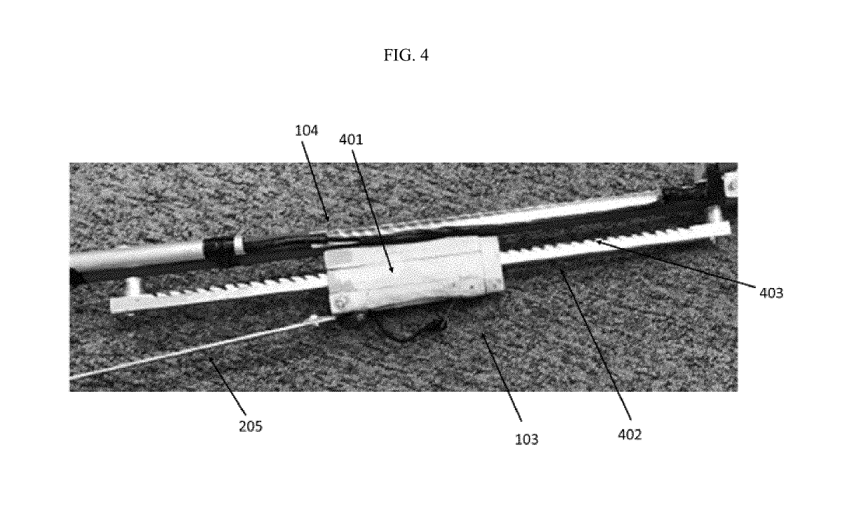

Elongated shaft 104 is also coupled to a gripping mechanism 103. FIG. 4 illustrates elements of the gripping mechanism 103.

FIG. 2 illustrates the securing mechanism 101. Securing mechanism 101 comprises a backer plate 201, a support member 203, and a loop mechanism 206. The backer plate 201 is configured to engaged with a surface of the object, and together with the loop mechanism 206, secure the object to the grabbing device. One end of the backer plate 201 can be secured to the distal end 105 of the elongated shaft 104 at coupling point 202. In some embodiments, coupling point 202 can provide a rotatable or pivotable connection. For example, coupling point 202 can allow the backer plate 201 and support member 203 to rotate about the distal end 105 of the elongated shaft 104. In one embodiment, the distal end 105 of the elongated shaft 104 can include a bracket that is connected to the backer plate 201. In other embodiments, the backer plate 201 can be coupled to the elongated shaft 104 using a bolt and nut extending through the rod. Such a configuration would allow the backer plate 201 to rotate or pivot about the distal end 105 of the elongated shaft 104.

The shape of the backer plate 201 can be any shape that provides structural integrity to the securing mechanism 101 and couples the securing mechanism 101 to the elongated shaft 104. For example, backer plate 201 could be a strut that connects the support member 203 to the elongated shaft 104. Backer plate 201 could also be oval or circle shaped, such as a rod. In other embodiments, back plate 201 could be a rod that couples the support member 203 to the elongated shaft 104.

The length of backer plate 201 can be adjustable. In one embodiment, backer plate 201 can include two plates that with multiple holes and the holes can be used to fasten the plates together at different lengths. The end of the backer plate 201 that is not coupled to the distal end 105 of the elongated shaft 104 is coupled to support member 203. Support member 203 is configured to slide underneath the object and support the object. Support member 203 can be made of any strong yet lightweight material such as aluminum, carbon fiber, or plastic. Support member 203 can be coupled to an actuating rod at coupling point 204. As described in detail below, actuating rod 205 can be manipulated to change the horizontal orientation of support member 203 and backer plate 201. Such functionality is desirable in some embodiments to maintain the horizontal orientation of an object, such as an open container, while the height of the object is changed.

Securing mechanism 101 also includes a loop mechanism 206. Loop mechanism 206 is configured to wrap around the object and secure the object to the backer plate. Loop mechanism 101 can be made of any flexible yet strong material that can be used to secure the object to the securing mechanism 101.

In one embodiment, loop mechanism 206 is a cable. According to that embodiment, one end of the cable is coupled to the distal end 105 of the elongated shaft 104. According to some embodiments, the cable extends from the distal end 105 of the elongated shaft 104 to the proximal end 106 of the elongated shaft. In one embodiment, the elongated shaft 104 is hollow and the cable can extend through the hollow portion of the elongated shaft 104. In another embodiment, the elongated shaft 104 includes a channel on an outer wall and the cable extends from the distal end 105 of the elongated shaft 104 to the proximal end 106 of the elongated shaft 104 in the channel. In another, embodiment, the cable is coupled to the distal end 105 of the elongated shaft 104 and the other end is coupled to a rod that extends from the distal end 105 of the elongated shaft 104 to the proximal end 106 of the elongated shaft 106.

In some embodiments, loop mechanism 206 comprises a material that is capable of retaining its shape. For example, loop mechanism 206 can be made of a shape-memory polymer. Shape-memory polymers are well known in the art. These polymers are capable of retaining their shape, e.g., they are malleable, and a user can manipulate their shape. The material will retain its shape until a stimulus, such a heat or electricity, is applied to the material. In these embodiments, the user can shape the loop to match the object to be grabbed. In these embodiments, the device can be used to grab irregularly shaped objects.

In some embodiments, the loop mechanism 206 comprises a wound or braided wire that includes a covering, such as an elastomeric covering. Such a covering protects the object from scratches or abrasions, according to one embodiment. In some embodiments, the loop mechanism 206 is made of other materials such as a synthetic rope or plastic tape or ribbon. In other embodiments, the loop mechanism 206 is made of another flexible yet strong material. For example, the loop mechanism 206 is made of a stiffer material that does not droop significantly, permitting it to be more easily secured around an object. In other embodiments, the loop mechanism 206 is made of a more flexible material such that the loop droops more, but can be used to secure large or irregularly shaped objects.

FIG. 3 illustrates support 102. Support 102 includes a forearm rest 301. Forearm rest further includes a handle 305. The forearm rest 301 is configured such that a user can rest his or her forearm on the forearm rest 301 and grip the handle 305. The forearm rest 301 can be constructed of wood, aluminum or other lightweight metal, carbon fiber, plastic, or foam, for example. In some embodiments, the forearm rest 301 includes an ergonomic shape. In some embodiments, the forearm rest 301 includes a foam or rubber cover to provide additional comfort and improved gripping. The handle 305 can be constructed of wood, aluminum or other lightweight metal, carbon fiber, or plastic, for example. In some embodiments, the forearm rest 301 includes a foam or rubber cover to provide additional comfort and improved gripping.

The forearm rest 301 overlies a toothed channel member 302. In one embodiment, the teeth 303 of the toothed channel member 302 interface with latching structures on the bottom side of the forearm rest 301. Forearm rest 301 can be slid forward or rearward on the toothed channel 302. The toothed channel 302 can also be used to lock the forearm rest 301 in place. In one embodiment, a cable that forms loop mechanism 206 is operatively coupled to the forearm rest 301. In another embodiment, a rod that is coupled to the loop mechanism 206 can be operatively coupled to the forearm rest 301. The cable or rod can be secured to the forearm rest 301 by any suitable mechanism, such as, for example, welding, bolting, gluing, taping, or using any other suitable adhesive. As explained in further detail below, sliding forearm rest 301 moves the cable or rod, thereby opening and closing the loop mechanism around the object. After the object is secured to the securing mechanism 101, forearm rest 301 can be locked to the teeth 303 of the toothed channel 302, thereby securing the object to the securing mechanism 101.

FIG. 4 illustrates gripping mechanism 103. Gripping mechanism 103 is coupled to the elongated shaft 104 between the securing mechanism 101 and the support 103. In some embodiments, gripping mechanism 103 is coupled to the elongated shaft 104 closer to the support 103. The gripping mechanism 103 includes a grip 401 and a toothed channel 402 with teeth 403. Grip 401 is coupled to actuating rod 205. Grip 401 is configured to slide on the toothed channel 402 to change the horizontal orientation of securing mechanism 101. Secure it against the teeth—pull it on the figures. Button control grip 401 further includes a securing mechanism configured to engage the teeth 403 of the toothed channel 402. In some embodiments, the securing mechanism can be a teeth that mirror teeth 403 and configured to engage teeth 403. Teeth 403 can secure the position of the grip 401 on the toothed channel 402, thereby locking the orientation of securing member 101.

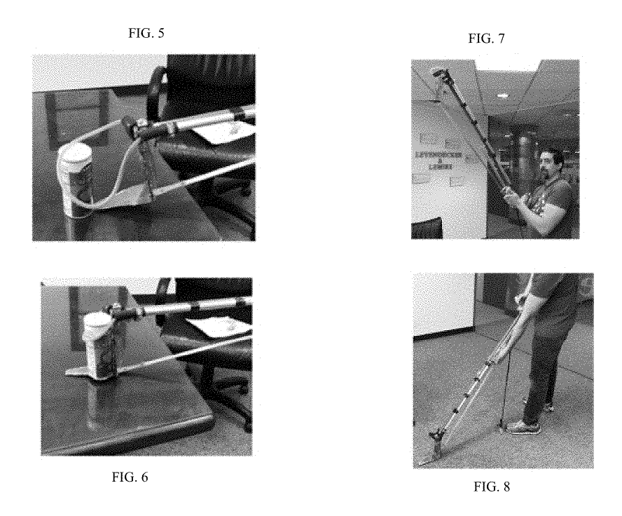

FIGS. 5, 6, and 7 illustrate a method of grabbing an object according to embodiments of the present disclosure. As shown in FIG. 5, the securing member 101 of the grabbing device 100 is advanced to the object. Loop mechanism 206 is manipulated around the object and support member 202 is positioned underneath the object. Next, in FIG. 6, the loop mechanism 206 is closed around the object to secure the object to the backer plate 201. In some embodiments, loop mechanism 206 can be closed around the object by sliding the forearm rest 301. For example, loop mechanism 206 can be coupled to forearm rest 301. There are many ways to couple loop mechanism 206 to forearm rest 301. For example, loop mechanism 206 can be glued, riveted, welded, taped, or otherwise secured to forearm rest 301. Forearm rest 301 can be slid on support 302, to change the diameter of loop mechanism 206. For example, when the forearm rest 301 is slid away from the proximal end of the elongated shaft 104, the diameter of the loop mechanism 206 becomes smaller, thereby securing the object to the device. When the forearm rest 301 is slid toward the proximal end of the elongated shaft 104, the diameter of the loop mechanism 206 becomes larger and the object would no longer be secured to the device. Once the loop mechanism 206 is closed around the object, forearm rest 301 can be secured to toothed channel 303, locking the object to the securing mechanism 101.

FIGS. 7 and 8 demonstrate the manipulation of grabbing device 100 to reach objects at different heights. As shown in FIG. 7, when the object to be reached is above the user, grip 401 can be advanced along the toothed channel 402 toward the proximal end 105 of the elongated shaft 104 to level support member 203. Once the support member 203 is level, grip 401 can be secured to the toothed channel 402 to lock the orientation of the support member. As shown in FIG. 8, when the object to be reached is below the user, grip 401 can be advanced along the toothed channel 402 toward the distal end 105 of the elongated shaft 104 to level support member 203. Once the support member 203 is level, grip 401 can be secured to the toothed channel 402 to lock the orientation of the support member.

Once the object has been moved to its desired located, forearm support 301 can be advanced toward the elongated shaft 104 to open the loop mechanism 206. After the loop mechanism 206 is opened, support member 203 can be slid out from under the object.

The construction of the various pieces and components of the grabbing device can vary greatly over what is shown in the disclosed embodiments. For example, the toothed channel 302 on the support 102 and the toothed channel 402 on the gripping mechanism 103 are configured allow lock the forearm support 301 and the grip 401 in place, respectively. Variations of these elements are contemplated that permit the forearm support 301 and grip 401 to be secured in place but that do not necessarily use toothed channel members. For instance, some friction inducing means, such as a brake pad(s) could be used to impinge on the forearm support 301 or grip 401 to hold each in place at a desired location and/or position. Further, the various elements can be made of other materials including but not limited to reinforced and unreinforced plastics.

Various modifications and additions can be made to the exemplary embodiments discussed without departing from the scope of the present disclosure. For example, while the embodiments described above refer to particular features, the scope of this invention also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A device for grabbing an object, comprising:
a support comprising a first grip and a rest;
an elongated shaft having a proximal end and a distal end, wherein the elongated shaft is coupled to the support;
a securing mechanism comprising a backer plate and a support plate, wherein the backer plate is coupled the elongated shaft and the support plate;
a second grip coupled to the elongated shaft; and
a loop mechanism coupled to the distal end of the elongated shaft, wherein the diameter of the loop mechanism can be adjusted by the user at the proximal end of the elongated shaft to secure the object to the securing member.

2. The device of claim 1, further comprising an actuating rod having first and second ends, wherein the first end of the actuating rod is coupled to the support plate and the second end of the actuating rod is coupled to the second grip, and wherein the actuating rod is configured to rotate the support plate about the shaft.

3. The device of claim 2, further comprising a first toothed channel coupled to the elongated shaft, wherein the second grip is slidably coupled to the first toothed channel.

4. The device of claim 3, the first toothed channel comprises teeth and wherein the second grip is configured to selectively engage the teeth of the first toothed channel to lock an orientation of the securing mechanism.

5. The device of claim 1, wherein the backer plate is pivotally coupled to the distal end of the elongated shaft.

6. The device of claim 1, wherein the backer plate has an adjustable length.

7. The device of claim 1, wherein the loop mechanism is configured to extend around the object.

8. The device of claim 7, further comprising a second toothed channel coupled to the proximal end of the elongated shaft, wherein the support is slidably coupled to the second toothed channel.

9. The device of claim 8, further comprising a securing rod having a distal end and a proximal end, wherein the distal end of the securing rod is operatively coupled to the loop mechanism.

10. The device of claim 9, wherein the proximal end of the securing rod is coupled to the support.

11. The device of claim 10, wherein the support is configured to slide relative to the second toothed channel, and wherein sliding the support moves the securing rod to open or close the loop mechanism around the object.

12. The device of claim 11, wherein the support is configured to selectively engage the teeth of the second toothed channel to lock the loop mechanism.

13. The device of claim 1, further comprising a securing cable having a distal end and a proximal end, wherein the distal end of the securing cable is operatively coupled to the loop mechanism.

14. The device of claim 1, wherein the support member is configured to fold against the backer plate.

15. The device of claim 1, wherein the loop mechanism extends from the distal end of the elongated shaft to the proximal end of the elongated shaft.

16. The device of claim 15, wherein the loop mechanism is coupled to the rest.

17. A method for grabbing an object, the method comprising:
positioning a support member under the object and a backer plate next to the object, wherein the backer plate is coupled to an elongated shaft having a proximal end and a distal end;
adjusting the diameter of a loop mechanism at the proximal end of the elongated shaft to secure the object to the backer plate, wherein
the loop mechanism is coupled to the distal end of the elongated shaft.

18. The method of claim 16, further comprising securing the support to lock the object to the backer plate.

19. The method of claim 16, further comprising sliding a grip operatively coupled to the support member and the backer plate to change the orientation of the support member and the backer plate.

20. The method of claim 17, further comprising securing the grip to lock the orientation of the support member and the backer plate.
